(19) United States
(12) Patent Application Publication
(10) Pub. No.: US 2007/0140507 A1
(43) Pub. Date: Jun. 21, 2007

(54) Sound distributor and a system for distributing sound

(75) Inventor: Hakon Hodne, Kleppe (NO)

Correspondence Address: BROOKS KUSHMAN P.C., 1000 TOWN CENTER, TWENTY-SECOND FLOOR, SOUTHFIELD, MI, 48075, US

(73) Assignee: LAERDAL MEDICAL AS, Stavanger (NO)

(21) Appl. No.: 10/598,040

(22) PCT Filed: Feb. 14, 2005
(86) PCT No.: PCT/NO05/00052

§ 371 Date: Dec. 8, 2006

(30) Foreign Application Priority Data
Feb. 16, 2004 (NO) 20040685

(51) Int. Cl. H04B 5/00; H04B 3/00

(52) U.S. Cl. 381/80; 381/79

(57) ABSTRACT

A sound distributor, for use in a system for distributing physiological sounds in a training manikin, the system comprising at least one acoustic source (5, 6), e.g., a loudspeaker, adapted to convert electrical signals from a signal generator into an acoustic signal. The sound distributor is an air filled structure (17-23), e.g., a pouch or bladder made of a flexible foil, comprising coupling means, e.g., an air filled sound conductor (14-16), for coupling to the acoustic source.

The present application relates to a sound distributor according to the preamble of claim 1 and a system for distributing physiological sounds in a training manikin, as defined in the preamble of the subsequent claim 6.

Medical personnel will gain substantial information of the physiological condition of a patient by listening for sounds on different parts of the patient body. This listening is generally performed by using a stethoscope.

To facilitate the training of medical personnel manikins have been designed that emit sound on different body areas. The type of sound can be chosen to indicate different physiological conditions. To achieve this loudspeakers are placed on various positions under the skin of the manikin. Typically, loudspeakers are placed in the position of the upper left lung, lower left lung, upper right lung, lower right lung, heart, bowel and arm. There may be one or more loudspeakers at each of these positions. A manikin having loudspeakers placed in this way is marketed by Laerdal Medical AS under the trade mark SimMan™.

With this manikin several physiological conditions can be simulated. Among these are:

| Sound Source | Physiological condition |
|---|---|
| Lung Sounds | Normal Breath Sounds |
| | Fine Crackles |
| | Coarse Crackles |
| | Pneumonia |
| | Wheeze |
| | Stridor |
| | Pleural Rub |
| | Rhonchi |
| Heart Sounds | Aortic Stenosis |
| | Friction Rub |
| | Austin Flint Murmur |
| | Dias Mur Mi Sten |
| | Systolic Murmur |
| | Mitral Valve Prolapse |
| | Normal Heart Sounds - Apex |
| | Opening Snap Msec |
| | Stills Murmur |
| | Ventricular Septal Defect (VSD) |
| | Atrial Septal Defect (ASD) |
| | Pulmonary Stenosis |
| Blood Pressure | Korotkoff sounds |
| Bowel sounds | Normal |
| | Borborygmus |
| | Hyperactive |
| | Hypoactive |
| | Fetal |

Using a manikin for training gives training possibilities that are not easy to achieve by using humans. If humans are used, it may be difficult to find patients that do have the exact physiological condition that it is a desire to train on. It may also be risky to train on a human being if the condition is serious. Moreover, it is time consuming, since the medical personnel to be trained must go from patient to patient that may find oneself on different locations.

With a manikin it is easy to switch from one physiological condition to another, and it is possible to simulate serious conditions that in the case of human beings would require immediate professional attention and would not be allowed for untrained personnel to train on.

Despite the fact that SimMan™ has given valuable training to a substantial number of health care takers, it is a desire to improve the function to bring the simulation even closer to real life.

It is also a desire to make the sound system easier to mount into the manikin, inter alia to make it possible to mount the system into a manikin with flexible skin.

In present manikins the loudspeakers are often mounted under the chest skin, so that the sound will come from the region where the lungs and heart is situated. It is also known to mount loudspeakers in the stomach region. This is a relatively soft region and the speakers must be covered with a plate made of a hard material in order not to be damaged by external forces applied during the training.

SimMan™ gives valuable training to a substantial number of health care takers. It is a desire to implement these training capabilities also on other manikins to make this kind of training available to an extensive number of health care takers. It is also a desire to provide a technology that makes it easier to control sound distribution in the manikin.

It is also difficult to mount the chamber and the loudspeaker in a flexible part of the manikin, e.g., the chest of a manikin with flexible chest skin. The chest will be exposed to forces from, e.g., chest compression due to heart compression. These forces will easily damage the loudspeaker or the chamber or the chamber may be pushed into nearby devices and damage these.

Moreover, with the present system it is difficult to control the spreading of the sound. The sound may be transferred into nearby equipment and thereby propagate over some distance and be emitted at another location than intended.

It is also difficult to mount the current system into existing manikins.

The present invention has as an object to solve one or more of the above mentioned problems. This is achieved by a sound distributor, for use in a system for distributing physiological sounds in a training manikin, the system comprising at least one acoustic source, e.g., a loudspeaker, adapted to convert electrical signals from a signal generator into an acoustic signal, wherein the sound distributor is an air filled structure comprising coupling means for coupling to the acoustic source.

This gives a far better flexibility in placement of the sound distributors.

According to a preferred embodiment the coupling means is an air filled sound conductor. This results in a great flexibility in the wiring of the sound conductor and a possibility to easily shorten or lengthen the conductor.

According to a specific embodiment of the invention the sound distributor is a pouch or bladder made of a flexible foil. This provides a low cost sound distributor that is easy to make and easy to place within the manikin.

Preferably, the sound distributor contains a volume maintaining device, to keep the air volume of the sound distributor intact, the volume maintaining device being a mat of foamed plastic, a mat of textile, a bow, a framework or the like. Thereby the sound distributor will not collapse permanently when force is exerted.

Preferably, the volume maintaining device is a mat of foamed plastic, a mat of textile, a bow, a framework or the like. This provides a low cost, easy to implement volume maintaining device.

The invention also prescribes a system for distributing physiological sounds in a training manikin, comprising at least one acoustic source, e.g., a loudspeaker, adapted to convert electrical signals from a signal generator into an acoustic signal, wherein the acoustic source is coupled to a first end of at least one air filled sound conductor, the second end being coupled to a sound distributor, to conduct the acoustic signal to the sound distributor placed at a distance from the acoustic source.

This results in a flexible sound distribution system, which is easy to mount and may be retrofitted.

Preferably, the sound conductor is a flexible hose, e.g., a plastic hose, with an internal diameter less than the wavelength of the sound. This results in a low cost system with great flexibility and good sound conductivity.

The sound distributor is a flexible air filled structure. This gives an increased flexibility in placement of the sound distributors.

Advantageously, the sound conductor is branched to conduct sound from one acoustic source to a multiple of sound distributors. Thereby it will be possible to direct sound from one sound source into different areas on the manikin.

Advantageously, it comprises a multiple of acoustic sources, each being placed in an individual box structure, the box structures being coupled to each other in a stack. This results in a compact unit and easy wiring of electric conductors and sound conductors.

The invention will be explained in more detail referring to the exemplary embodiment shown in the accompanying figures, in which:

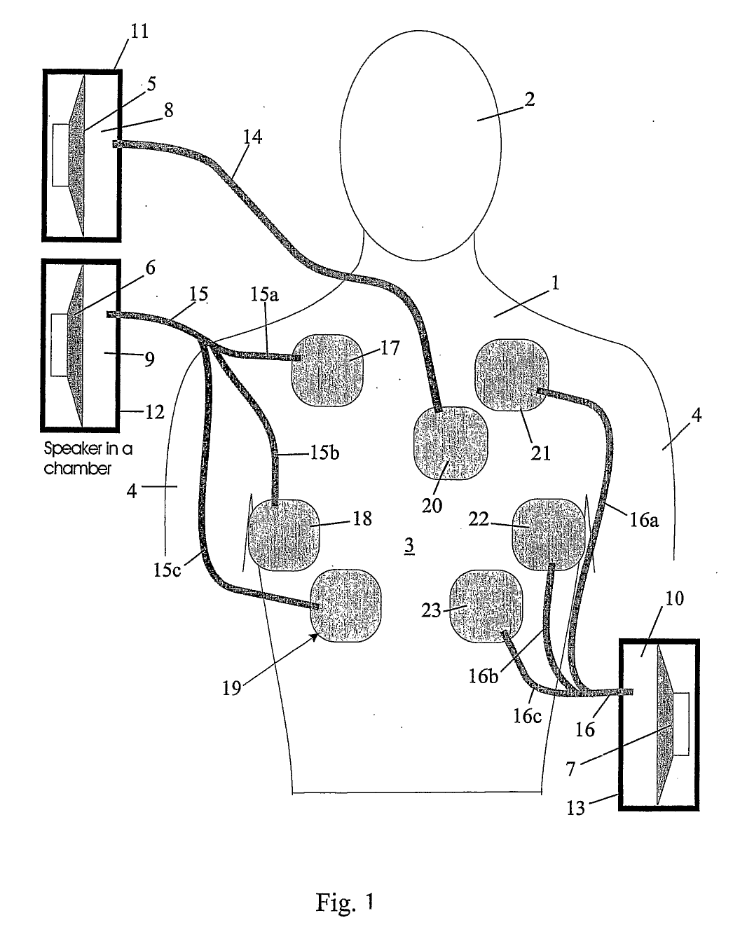

FIG. 1 shows schematically the upper part of a manikin with an implemented sound system according to the present invention,

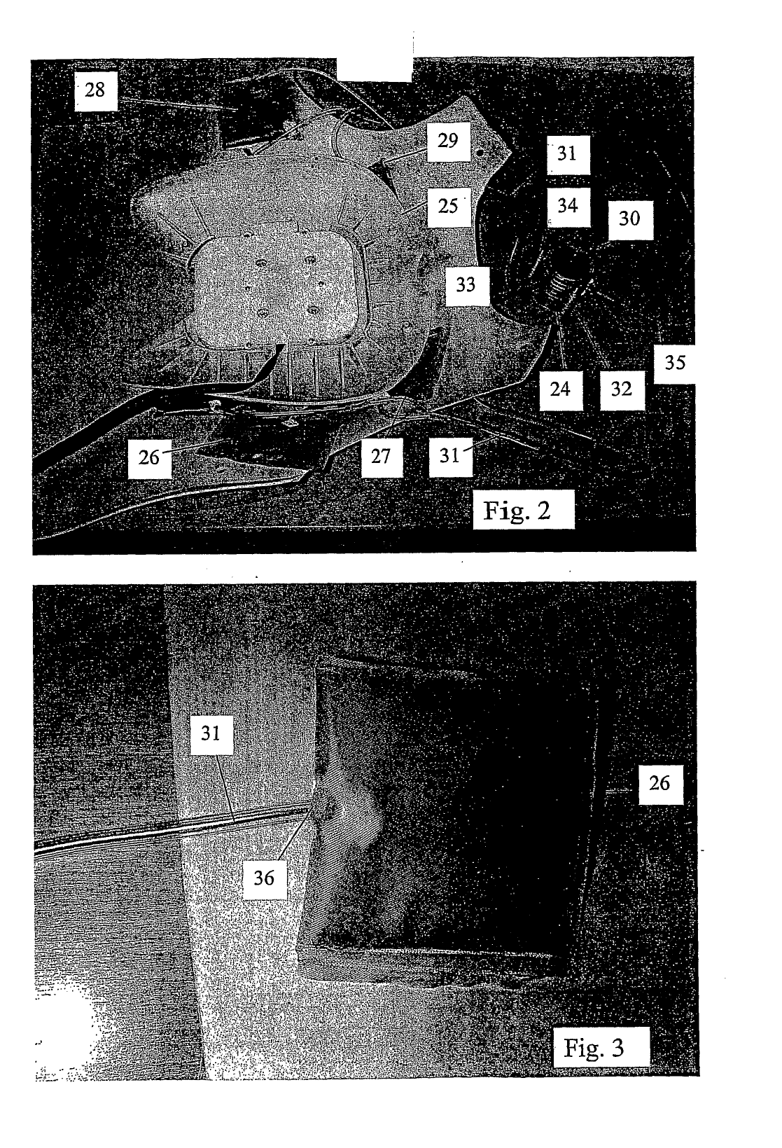

FIG. 2 shows a chest skin with sound pouches or bladders and a stack of loudspeakers according to a preferred embodiment of the present invention, and

FIG. 3 shows a detail of a sound pouch or bladder according to a preferred embodiment of the present invention.

Referring first to FIG. 1 this shows schematically the upper part of a manikin 1. The manikin 1 has a head 2, a chest 3 and arms 4. It may also have a lower body part, but this is not necessarily the case. FIG. 1 also shows schematically a sound system according to the present invention. The sound system comprises in this case three loudspeakers 5, 6, 7. The loudspeakers 5, 6, 7 are placed in a respective acoustic chamber 8, 9, 10, defined within a box structure 11, 12, 13. The loudspeakers are connected to an amplifier in a conventional way via electrical conductors (not shown). The manner in which the sound is generated into the loudspeakers is conventional and will not be explained in detail here.

From the chambers 8, 9, 10 flexible tubular members (e.g. hoses) 14, 15, 16 extend. The hoses 14, 15, 16 may be branched into hoses 15a, 15b, 15c, 16a, 16b, 16c. Each hose or branch is at its opposite end connected to a sound pouch or bladder 17, 18, 19, 20, 21, 22, 23.

When sound is generated in the loudspeaker 5, the sound will propagate from the chamber 8 into the hose 14 and emitted from the sound pouch or bladder 20. A person listening, e.g., with a stethoscope, in the area close to the pouch or bladder 20, will hear the sound generated by the loudspeaker 5.

When sound is generated in the loudspeaker 6, the sound propagates from the chamber 9 into the hose 15, further into the branch hoses 15a, 15b and 15c, and is emitted from the pouches or bladders 17, 18 and 19. This means that a person listening in the area around any of the pouches or bladders 17, 18 or 19 will hear the sound.

Similarly the sound generated in the loudspeaker 7 will propagate to the pouches or bladders 21, 22 and 22 via the hose 16 and the branch hoses 16a, 16b, 16c, so that a person listening in the area around any of these pouches or bladders will hear the sound

FIG. 1 shows only a few of the possible placements of pouches or bladders. Any reasonable number of pouches or bladders may be connected to a specific loudspeaker, and any reasonable number of loudspeakers may be utilized. It is also possible to connect two or more loudspeakers to the same bladder.

The loudspeakers can be placed anywhere in the manikin, making it possible to utilize the space that is available no matter where this may be in the manikin. It is also possible to place the loudspeakers outside of the manikin.

FIG. 2 shows the inside of a flexible chest skin 24 of a manikin. The inner part 25 of the chest is also shown.

Here is shown four sound pouches or bladders 26, 27, 28, 29 that are partly placed between the outer chest skin 24 and the inner part 25 of the chest. The pouches or bladders are connected to a set of three loudspeakers 30 via hoses 31. The loudspeakers 30 are placed in a respective chamber 32, defined by a box structure 33. In this embodiment the box structures 33 are placed on top of each other in a stack. The box structures have a circular cross section that is only slightly larger than the circular loudspeaker, to take up as little room as possible. Each box structure has three lugs 34 at different locations along the perimeter, through which a bolt can be inserted to hold the stack of box structures 33 together. Thereby the whole stack can be placed at one location in the manikin. This facilitates the wiring, since all wires 35 from the amplifier can be wired through the same path. The hoses 31 may also be partly be lead through the same path.

FIG. 3 shows a sound bladder 26 according to a preferred embodiment of the present invention. The bladder 26 shown is square in shape, but may be of any other shape, the shape and size depending on the desired spreading of the sound.

The bladder 26 is preferably made of a thin flexible material, e.g. a sheet of plastic foil that is bent double and welded, glued or otherwise joined at the edges to form a closed volume between two sides of foil. Inside the bladder is means for keeping the hollow of the bladder to a desired volume and preventing the sides of foil from being permanently squeezed together. The means for keeping the volume may preferably be a mat of foamed plastic (as shown in FIG. 3) or textile or a plastic bow or framework, placed between the two sides of foil.

A tube 31 is connected to the bladder through an opening 36. The connection may be air tight, but even if it is not air tight the sound will propagate into the bladder.

The bladder may be fastened to the chest skin or other parts of the manikin by any feasible means, like double sided tape, adhesive, hook and loop (Velcro™), a pocket made in the chest skin or by small holes in the bladder, through which pegs formed on the chest skin may be inserted.

The sound distributor may also be made of several smaller structures that may be flexible or stiff and linked together and having sound channels therebetween. Depending on the placement in the manikin body the sound distributor may also be rigid.

1. A sound distributor, for use in a system for distributing physiological sounds in a training manikin, the system comprising at least one acoustic source, e.g., a loudspeaker, adapted to convert electrical signals from a signal generator into an acoustic signal, characterized in that it is an air filled structure comprising coupling means for coupling to the acoustic source.

2. Sound distributor according to claim 1, characterized in that said coupling means is an air filled sound conductor.

3. Sound distributor according to claim 1, characterized in that it is a pouch or bladder made of flexible foil.

4. Sound distributor according to claim 1, characterized in that it contains a volume maintaining device, to keep the air volume of the sound distributor intact.

5. Sound distributor according to claim 4, characterized in that the volume maintaining device is a mat of foamed plastic, a mat of textile, a bow, a framework or the like.

6. A system for distributing physiological sounds in a training manikin, comprising at least one acoustic source, e.g., a loudspeaker, adapted to convert electrical signals from a signal generator into an acoustic signal, characterized in that the acoustic source is coupled to a first end of at least one air filled sound conductor, the second end being coupled to a sound distributor, to conduct the acoustic signal to the sound distributor placed at a distance from the acoustic source.

7. System according to claim 6, characterized in that the acoustic source is situated in a structure defining a chamber.

8. System according to claim 6, characterized in that the sound conductor is a flexible hose, e.g., a plastic hose, with an internal diameter less than the wavelength of the sound.

9. System according to claim 6, characterized in that the sound distributor is a flexible air filled structure.

10. System according to claim 6, characterized in that the sound conductor is branched to conduct sound from one acoustic source to a multiple of sound distributors.

11. System according to claim 6, characterized in that it comprises a multiple of acoustic sources, each being placed in an individual structure, the structures being coupled to each other, e.g. in a stack.
